(19) United States
(12) Patent Application Publication
(10) Pub. No.: US 2007/0043830 A1
(43) Pub. Date: Feb. 22, 2007

(54) System and methods for collaborative scrapbook creation

(76) Inventors: Jeffery Housenbold, Menlo Park, CA (US); Xin Wen, Palo Alto, CA (US)

Correspondence Address: Xin Wen, 2800 Bridge Parkway, Redwood City, CA, 94065, US

(21) Appl. No.: 11/207,666

(22) Filed: Aug. 19, 2005

(51) Int. Cl. G06F 15/16

(52) U.S. Cl. 709/219

(57) ABSTRACT

A system for creating a scrapbook by a plurality of users includes a computer storage device configured to store book-design information for a scrapbook comprising a plurality of pages and an image on at least one of the plurality of pages, one or more first computer servers configured to retrieve the book-design information from the computer storage device and to transmit at least a portion of the book-design information to a plurality of computer devices through a computer network to enable the display of one or more pages of the scrapbook, and one or more second computer servers configured to receive input to the scrapbook through the computer network from the plurality of computer devices and to store the input to the scrapbook in association with the book-design information on the computer storage.

### CROSS-REFERENCES TO RELATED INVENTIONS

The present invention is related to commonly assigned U.S. patent application Ser. No. 10/106,902 [Attorney Docket no. SF046001], filed on Mar. 25, 2002, titled “Producing and sharing personalized photo calendars”, U.S. patent application Ser. No. 11/086,579 [Attorney Docket no. SF012C003], filed on Mar. 22, 2005, titled “Utilization of digital images”, and U.S. patent application Ser. No. 11/176,049 [Attorney Docket no. SF055001], filed on Jul. 7, 2005, titled “Automatic generation of a photo album”. The disclosure of these related applications are incorporated herein by reference.

### TECHNICAL FIELD

This application relates to the utilization of digital images, specifically the design of image-based products.

### BACKGROUND

Scrapbooking is a creative activity for preserving people's memories. A scrapbook can include multiple pages. Each page can include text, illustrations, background designs, decorations by the scrapbook creator. and photographic pictures.

Scrapbooking can also be a social event. A group of scrapbook enthusiasts can get together to share ideas on content, designs, layout, book-making techniques, or picture preservation tips in a workshop and at a home class. Several people can jointly create a scrapbook at such a social event. Scrapbooking is an increasingly popular phenomenon that appeals to people's longing for preserving memories, strengthening relationship, and enriching communities. A large number of scrapbooking groups exist in the United States.

The spreading of scrapbooking activities, however, has been inhibited by several limitations. Although common memories shared by family members perhaps hold the largest source materials for scrapbooking, scrapbooking gatherings are often impractical for family members residing at distant locations. Furthermore, a group of people living in the same community can also have difficulties to find common time for a workshop because of obligations to other daily activities.

### SUMMARY

In one aspect, the present application relates to a system for creating a scrapbook by a plurality of users, comprising:

a computer storage device configured to store book-design information for a scrapbook comprising a plurality of pages and an image on at least one of the plurality of pages;

one or more first computer servers configured to retrieve the book-design information from the computer storage device and to transmit at least a portion of the book-design information to a plurality of computer devices through a computer network to enable the display of one or more pages of the scrapbook; and

one or more second computer servers configured to receive input to the scrapbook through the computer network from the plurality of computer devices and to store the input to the scrapbook in association with the book-design information on the computer storage.

In another aspect, the present application relates to a system for creating a scrapbook by a plurality of users, comprising:

a computer storage device configured to store book-design information for a scrapbook, wherein the book-design information includes page layout information including one or more of image objects and/or text objects for at least one page of the scrapbook;

one or more first computer servers configured to retrieve the book-design information from the computer storage device and to transmit at least a portion of the book-design information to a plurality of computer devices through a computer network to enable the display of one or more pages of the scrapbook; and

one or more second computer servers configured to receive input to the scrapbook through the computer network from the plurality of computer devices,

wherein the storage device is configured to incorporate the input to the scrapbook from the plurality of computer devices into the book-design information in association with the scrapbook.

In yet another aspect, the present application relates to a method for creating a scrapbook by a plurality of users, comprising:

producing page layout information including one or more of image objects and/or text objects for at least one page of the scrapbook;

storing the page layout information for the scrapbook on a computer storage device;

transmitting the page layout information to a plurality of computer devices through a computer network;

displaying one or more pages of the scrapbook in accordance with the page layout information;

receiving input to the scrapbook through the computer network from the plurality of computer devices; and

incorporating the input to the scrapbook from the plurality of computer devices into the page-layout information stored on the storage device.

Embodiments may include one or more of the following advantages. The disclosed system and methods enable scrapbook enthusiasts to collaboratively contribute to the same scrapbook from remote locations. Multiple scrapbook enthusiasts can contribute content and design to the same scrapbook without meeting in person. The input from the multiple of scrapbook enthusiasts can be collected and incorporated in the same scrapbook template. The scrapbook can be displayed and viewed at the remote locations. An editor can edit the scrapbook to its final form. Different versions of the scrapbook information can be saved and stored on a network storage device and made available for display to the scrapbook enthusiasts.

Another advantage of the disclosed system and methods is that they provide flexibility in creating the scrapbooks. A number of scrapbook enthusiasts can contribute to a scrapbook at the same times, at partially overlapping times, or at different times. The input to the scrapbook can be simultaneously collected and stored at the network storage device. Alternatively, the input to the scrapbook can be collected and stored at different times.

Yet another advantage of the disclosed system and methods is the flexible page layout that allows different scrapbook enthusiasts to contribute to the same page or even the same object within a page of a scrapbook. The input from the different users will not create conflicts. One of the scrapbook enthusiasts can act as an editor to incorporate the input from all scrapbook enthusiasts to finalize the book design.

### DRAWING DESCRIPTIONS

In order that the manner in which the above-recited and other advantages and features of the invention are obtained, a more particular description of the invention briefly described above will be rendered by reference to specific embodiments thereof, which are illustrated, in the appended drawings. Understanding that these drawings depict only typical embodiments of the invention and are not therefore to be considered to be limiting of its scope, the invention will be described and explained with additional specificity and detail through the use of the accompanying drawings in which:

The accompanying drawing, which are incorporated in and form a part of this specification, illustrate embodiments of the invention and, together with the description, serve to explain the principles of the invention:

FIG. 1 is a block diagram of a network-based system.

FIG. 2 is a flow chart for creating a scrapbook by a plurality of collaborative users.

FIG. 3 illustrates an example of creating a scrapbook by a plurality of collaborative users.

FIG. 4 illustrates another example of creating a scrapbook by a plurality of collaborative users.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

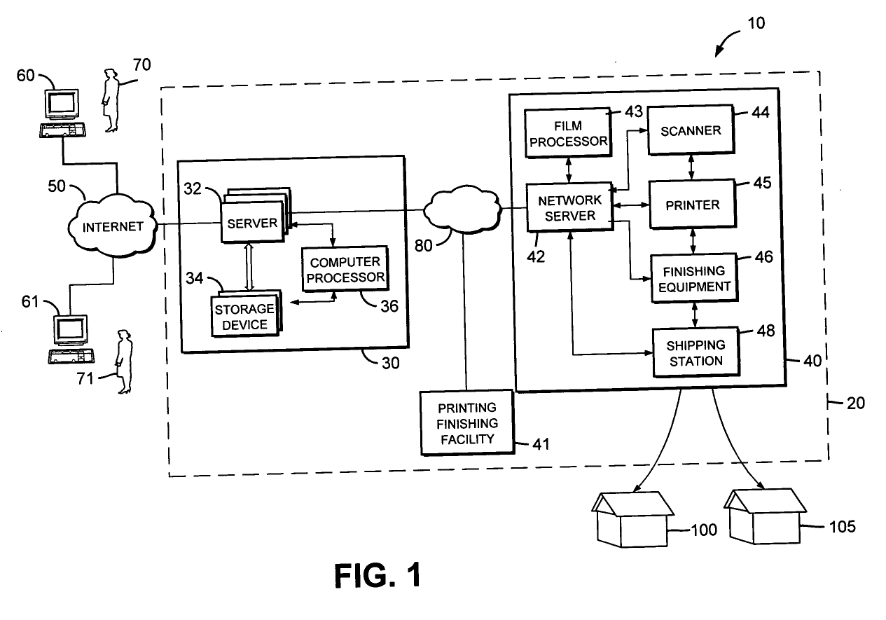

FIG. 1 shows a block diagram of the system 10 for collaboratively creating a scrapbook by multiple contributors. A network-based system 20 is in communication with a plurality of computer devices 60 and 61 through a computer network such as the Internet 50 and wireless network based on various communication protocols such as WI-FL, W-Max, and 802.11. The computer devices 60 and 61 can include desktop or laptop personal computers, portable computer devices such as personal digital assistance (PDA), cellular phones, etc. The network-based system 20 includes a data center 30 and one or more printing and finishing facilities 40 and 41 that are connected by a network 80

The data center 30 can include one or more servers 32 and data storage devices 34 for storing book-design information for the scrapbooks. The data center 30 can also include one or more computer processors 36 for processing orders and rendering the scrapbook pages and covers in accordance to the scrapbook-design information. In the present invention, the term “scrapbook” refers to a book that includes one or two cover pages and one or more pages. The pages can be sequenced by page numbers. The scrapbook can include one or more images, text, image caption, and graphic one or more of the pages. The book-design information can include page-layout information for the pages in the scrapbook, image data, image positions on a page, text information, text location on a page, the sequence of the pages, page numbers, graphic designs, decorations, properties of the book cover, and binding information. The scrapbook can be bound, glued, or include refillable pages to a binder. The scrapbook cover can also include different types of materials, textures and colors. Scrapbook can also be referred as photo albums, photo books, snap books, and any books form including bound image pages and information contributed by the users.

The book-design information can be contributed by a plurality of users. A single page or a single object on a page of the scrapbook can include input from different users. The storage devices 34 can also include user account information such as user names of the scrapbook enthusiasts contributing to the same scrapbook and password for the users. The storage devices 34 can also include information for the scrapbook orders.

An Internet website can be powered by the servers 32 to serve as a web interface between the users 70 and 71 and the network-based system 20. The users 70 and 71 can view the scrapbook designs, provide input to the scrapbook, and order scrapbooks through the web interface. The printing and finishing facilities 40 and 41 can print and finish the scrapbooks. Finishing can include operations such as cutting, folding, gluing and binding the scrapbooks.

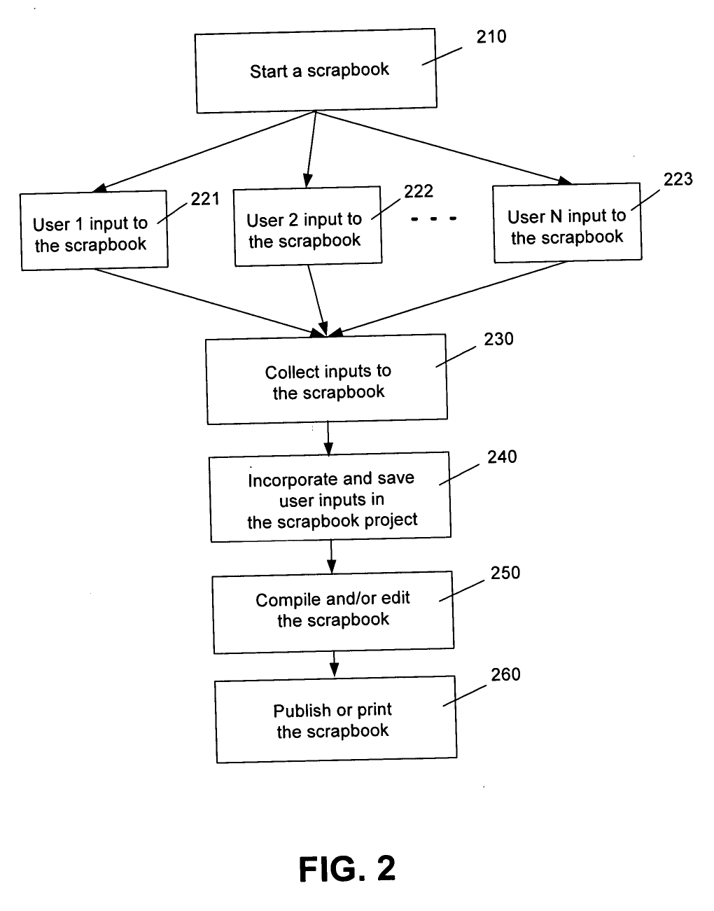

FIG. 2 is a flow chart for collaboratively creating a scrapbook by a plurality of users. A scrapbook project can be started by the user 70 in step 210 using the web interface such as an Internet Browser to the website. The scrapbook can include a plurality of pages and covers. Each page or cover can include one or more image objects and text objects. The scrapbook-design information can be saved by the user 70 as a scrapbook project on the storage devices 34 to allow users 70 and 71 to access the scrapbook project and make contributions to the scrapbooks.

In steps 221-223, different users 70 and 71 or “User 1”, “User 2”, “User N” can access the saved scrapbook project using computer devices 60 and 61 from different locations. The computer devices 60 and 61 can receive from the servers 32 update-to-date book-design information saved on the storage device 34. The users 70 and 71 can each view the page layouts of the scrapbook on a display device in communication with the computer devices 60 and 61. Update-to-date book-design information saved on the storage device 34 can be synchronously displayed and viewable by the users 70 and 71. The users 70 and 71 can enter their inputs to the scrapbook using computer devices 60 and 61 via the web interface. For example, the page layout of the scrapbook can include text boxes for receiving text information or image area for receiving images from the users operating variously computer devices 60 and 61. The users 70 and 71 may be able to drag an image file from the computer device 70 and 71 and dropped the image file in the image are. The inputs are instantly transmitted to the servers 32 over the Internet 50 and collected in step 230 and incorporated and saved in the scrapbook project on the storage device 34 in step 240. The steps 221-223 to step 240 can be repeated multiple times before all the input are collected from the users 70 and 71.

An advantage of the disclosed system 10 is that it allows users 70 and 71 to provide their input to the scrapbook at different locations, thus collaboratively creating a scrapbook without the need for a face-to-face meeting. They can also enter their input at times convenient to them, which can be at a same period of time or at different times. The input information from the users 70 and 71 can be collected by the servers 32 and storage devices 34 simultaneously, at different times, or with a time delay. For example, as an alternative to a web browser interface to the system 10, the user 70 and 71 can also download a software application on to the computer device 60. The application software can receive parameters for defining page layouts of a scrapbook and functions for receiving scrapbook-design information. The software application can display the page layout of the scrapbook pages on a display device in accordance to the scrapbook-design information. Input by a user to the software application can be locally stored on the computer devices 60 and 61 and can be transmitted to the servers 32 in a synchronous or asynchronous manner.

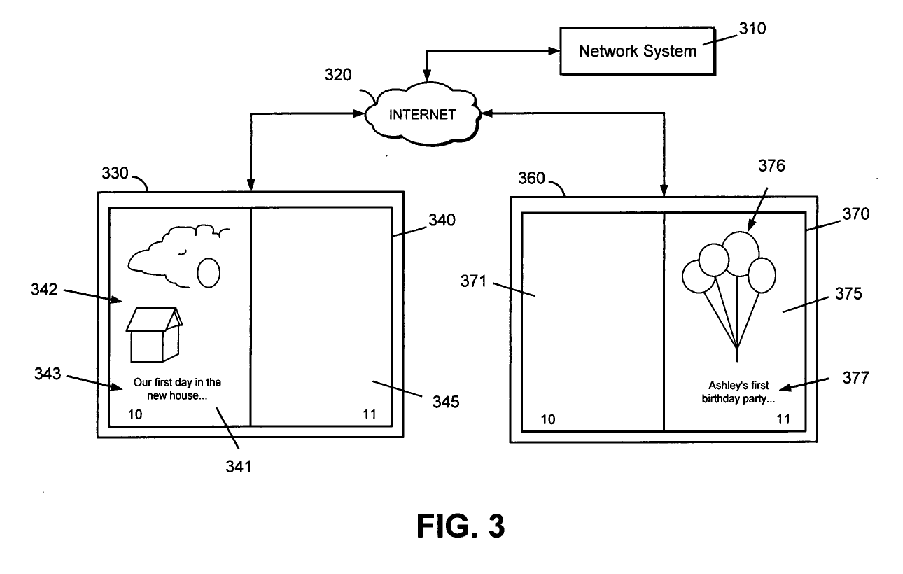

The scrapbook project includes several features to enable collaborative contributions by a plurality of users 70 and 71. The scrapbook template include page layout for each page that include one or more fields for receiving the image or text objects. The fields for the objects can be fixed in the page layout or can be moved by a user 70 or 71. For example, pages 10 and 11 (pages 341 and 345) are displayed in a web interface 340 of a display device 330 that can be part of the computer device 60 as shown in FIG. 3. Page 441 includes image object 342 and a text object 343. Similarly, pages 10 and 11 (pages 371 and 375) can also be displayed in a web interface 370 of a display device 360 that can be part of the computer device 61. The image objects 342 and 376 and text objects 343 and 377 can be previously input by other users 70 and 71. Users 70 and 71 can also make input to the scrapbook simultaneously. The input can be transmitted to the network system 310 through the Internet 320 and collected by the servers 32 and storage devices 34.

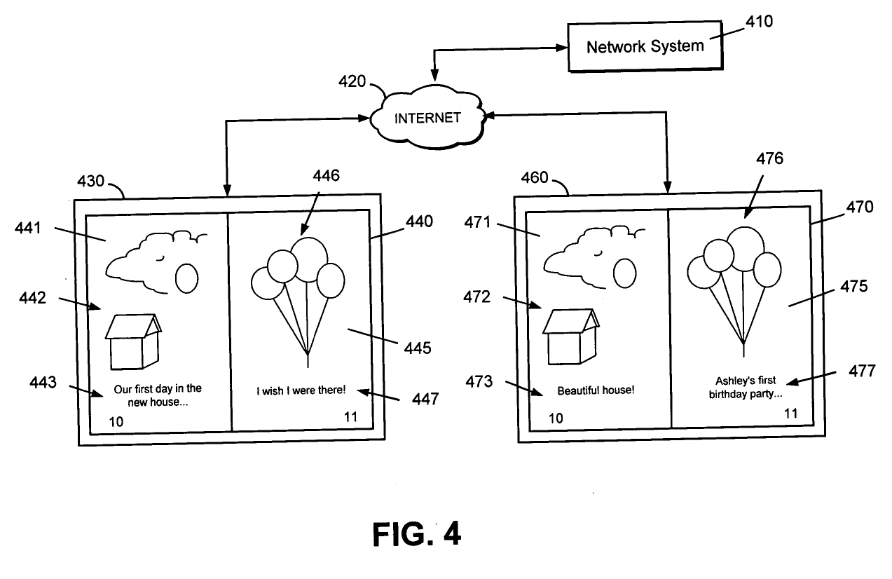

The scrapbook template allows multiple inputs to the same page or the same object on a page from different users. FIG. 4 illustrates how different users 70 and 71 can contribute to the same objects on a page of a scrapbook. Pages 10 and 11 (pages 441 and 445) are displayed in a web interface 440 of a display device 430 that can be part of the computer device 60. Page 441 includes image object 442 and a text object 443 entered by the user 70. Page 445 includes image object 446 and text object 447 input by the user 70. Pages 10 and 11 (pages 471 and 475) are also displayed in a web interface 470 of a display device 460 that can be part of the computer device 61. Page 471 (illustrating page 10 of the scrapbook) includes an image object 472 that is the same as image object 442. Page 471 can also include a text object 473 input by the user 71 at the same page location as the text object 443 on page 441 displayed on the display device 430. Similarly, Page 11 can be displayed as page 445 on the web interface 440 or as page 475 on the web interface 470. The image object 446 can be the same as image object 476, while different input by users 70 and 71 can be made in text object 447 and text object 477 by different users 70 and 71. The input by the users 70 and 71 are transmitted to the network system 410 through the Internet 420 and collected by the servers 32 and storage devices 34.

The template in the scrapbook can allow multiple layers for each page of the scrapbook to capture the input on the same page or the same object of a page by the different users 70 and 71. Different layers can capture different inputs for the same page or the same object(s) on the same page of the scrapbook. The different layers can be saved as redundant pages such as “Page 10”, “Page 10A”, “Page 10B”, etc., wherein “Page 10A” and “Page 10B” are redundant pages to “Page 10”. Alternatively, the layers can be implemented as HTML layers that can superimpose on the same page. The redundant input to the same page or objects can be compiled or edited after all the inputs are collected. In contrast, prior art systems only allow a single user to contribute to the design of an image-based product at each time. Multiple inputs to the same object are not allowed.

A user 70, 71 can compile and edit the scrapbook in step 250. The user 70 can edit the scrapbook while other users are still making inputs to the scrapbook, or wait till all the inputs are collected and saved on the storage device 34. The scrapbook can be published on the web and/or printed through an order to the system 10 by users 70 and 71 in step 260.

What is claimed is:

1. A system for creating a scrapbook by a plurality of users, comprising:
a computer storage device configured to store book-design information for a scrapbook comprising a plurality of pages and an image on at least one of the plurality of pages;
one or more first computer servers configured to retrieve the book-design information from the computer storage device and to transmit at least a portion of the book-design information to a plurality of computer devices through a computer network to enable the display of one or more pages of the scrapbook; and
one or more second computer servers configured to receive input to the scrapbook through the computer network from the plurality of computer devices and to store the input to the scrapbook in association with the book-design information on the computer storage.

2. The system of claim 1, wherein the book-design information includes page layout information for a page that includes one or more of objects.

3. The system of claim 2, wherein the objects include one or more of an image, text, or a design.

4. The system of claim 2, wherein at least one of the objects includes input by a plurality of users from the plurality of computer devices.

5. The system of claim 1, wherein the book-design information includes one or more of page-layout information for one or more pages in the scrapbook, image data, image location on a page, text information, text location on a page, the sequence of the pages, page numbers, graphic design information, properties of the book cover, and binding information.

6. The system of claim 1, wherein the one or more first computer servers are configured to synchronously update the displays of one or more pages of the scrapbook at the plurality of computer devices in accordance with the book-design information and the input to the scrapbook.

7. The system of claim 1, wherein the one or more second computer servers are configured to simultaneously receive input from the plurality of computer devices.

8. The system of claim 1, wherein the one or more second computer servers configured to receive input to the scrapbook from the plurality of computers at different times.

9. The system of claim 1, wherein at least one or the second computer servers is the same as one of the first computer servers.

10. A system for creating a scrapbook by a plurality of users, comprising:
a computer storage device configured to store book-design information for a scrapbook, wherein the book-design information includes page layout information including one or more of image objects and/or text objects for at least one page of the scrapbook;
one or more first computer servers configured to retrieve the book-design information from the computer storage device and to transmit at least a portion of the book-design information to a plurality of computer devices through a computer network to enable the display of one or more pages of the scrapbook; and
one or more second computer servers configured to receive input to the scrapbook through the computer network from the plurality of computer devices,
wherein the storage device is configured to incorporate the input to the scrapbook from the plurality of computer devices into the book-design information in association with the scrapbook.

11. The system of claim 11, wherein at least one of the image objects and/or text objects includes input by a plurality of users from the plurality of computer devices.

12. The system of claim 11, wherein the one or more second computer servers are configured to simultaneously receive input from the plurality of computer devices.

13. The system of claim 11, wherein the one or more second computer servers configured to receive input to the scrapbook from the plurality of computers at different times.

14. The system of claim 11, wherein at least one or the second computer servers is the same as one of the first computer servers.

15. A method for creating a scrapbook by a plurality of users, comprising:
producing page layout information including one or more of image objects and/or text objects for at least one page of the scrapbook;
storing the page layout information for the scrapbook on a computer storage device;
transmitting the page layout information to a plurality of computer devices through a computer network;
displaying one or more pages of the scrapbook in accordance with the page layout information;
receiving input to the scrapbook through the computer network from the plurality of computer devices; and
incorporating the input to the scrapbook from the plurality of computer devices into the page-layout information stored on the storage device.

16. The method of claim 15, further comprising:
receiving input to at least one of the image objects and/or text objects in the page layout information by a plurality of users from the plurality of computer devices through the computer network.

17. The method of claim 15, further comprising:
simultaneously receiving input to the scrapbook through the computer network from the plurality of computer devices.

18. The method of claim 15, further comprising:
receiving input to the scrapbook through the computer network from the plurality of computer devices at different times.

19. The method of claim 15, further comprising:
downloading a book template to at least one of the computer devices to display the one or more pages of the scrapbook.

20. The method of claim 15, further comprising:
synchronously displaying one or more pages of the scrapbook at the plurality of computer devices in response to the input to the scrapbook from the plurality of computer devices.
